(19) United States
(12) Patent Application Publication
(10) Pub. No.: US 2026/0180334 A1
(43) Pub. Date: Jun. 25, 2026

(54) METHOD FOR OPERATING A POWER CONVERTER COMPRISING A GRID-FORMING CONTROL SYSTEM

(71) Applicant: SMA Solar Technology AG, Niestetal (DE)

(72) Inventors: Andreas Knobloch, Kassel (DE); Boris Fischer, Kassel (DE); Abdulkader Zabarah, Kassel (DE); Mohamed Khshainy, Kassel (DE); Chokri Khalfet, Kassel (DE)

(21) Appl. No.: 19/424,817

(22) Filed: Dec. 18, 2025

(30) Foreign Application Priority Data
Dec. 19, 2024 (DE) 102024139134.0

(51) Int. Cl. H02J 3/36; H02J 3/38; H02J 101/24; H02M 7/5387

(52) U.S. Cl. CPC H02J 3/36; H02J 3/381; H02M 7/53871; H02J 2101/25

(57) ABSTRACT

The disclosure relates to a method for operating a power converter for exchanging electrical power (P_{DC}, P_{AC}) between a DC unit and an AC grid. The DC unit is connected to a DC terminal of the power converter and exchanges a DC power (P_{DC}) with the power converter based on a DC voltage (U_{DC}) at the DC terminal. The AC grid is connected to an AC terminal of the power converter and exchanges an AC power (P_{AC}) with the power converter based on a deviation between an AC voltage profile (U_{AC}) generated by a clocked bridge circuit of the power converter and a grid voltage profile (U_{grid}) via the AC terminal. The power converter uses a grid-forming AC control system to adjust the AC voltage profile (U_{AC}) based on an AC power control value (P_{AC,set} ).

### REFERENCE TO RELATED APPLICATION

This Application claims the benefit of German Application number 102024139134.0, filed on Dec. 19, 2024, the contents of which are hereby incorporated by reference in their entirety.

### FIELD

The disclosure relates to a method for operating a power converter for exchanging electrical power between a DC unit and an AC grid, to a power converter comprising a grid-forming AC control system, and to an energy supply system.

### BACKGROUND

Conventional energy supply systems, for example, thermally operated power plants and also hydroelectric power systems, comprise grid-synchronous rotating flywheel masses of synchronous generators or turbines and the corresponding drive train. Such energy supply systems exchange electrical power with an electrical AC voltage grid, wherein the entire flywheel mass of the systems is electromechanically effective and contributes significantly within the grid to the stabilization of the AC voltage grid. Due to the rotational energy stored therein, the inertia of the corresponding flywheel mass in particular causes an inertia of the rotating voltage space phasor of the conventional energy supply systems with respect to the voltage space phasor in the AC voltage grid. This results in an instantaneous change in the power supply of the energy supply systems during phase shifts and/or frequency changes of the voltage space phasor in the AC grid, which change is caused in particular by inductive effects and a phase angle difference between the voltage space phasor of the flywheel mass and the voltage space phasor of the grid voltage.

In this respect, a conventional energy supply system provides a so-called instantaneous reserve and limits the rate of change of the frequency of the AC voltage grid, in particular in the event that power imbalances between the inflow and outflow of electrical power, i.e. between generation and consumption in the AC voltage grid, occur relatively suddenly, for example, due to a fault in a transmission line in the AC voltage grid.

The power exchanged as an instantaneous reserve power between the energy supply system and the AC voltage grid is drawn from or supplied to the rotating mass of conventional energy supply systems by decelerating or accelerating the corresponding flywheel mass, wherein the overall power and energy exchanged are limited by the physical characteristics of the energy supply system as a whole. The provision of the instantaneous reserve ends as soon as the voltage space phasor of the flywheel mass has synchronized with the voltage space phasor of the grid and its rotation frequency has matched the grid frequency, i.e. in particular as soon as the grid frequency has stopped drifting, for example after the power imbalance has been eliminated by further frequency stability mechanisms or a grid self-regulating effect.

Energy supply systems that exchange electrical power with the AC voltage grid via power electronics converters, such as photovoltaic systems, wind turbines or grid-connected energy storage systems, generally do not have physical masses rotating synchronously with the voltage angle of the grid and therefore, from a grid perspective, lack suitable mechanical inertia, have very little or no mechanical storage capacity and have low overcurrent capability. The power electronics converters of such energy supply systems, for example, inverters, can be designed for the grid-following exchange of a specified electrical power with an existing AC voltage grid and, at best, support the construction of an island grid.

Grid-following power exchange means that a converter, for example, a power converter, synchronizes its AC-side alternating voltage with an existing grid in terms of voltage angle and voltage amplitude. The converter follows the grid in terms of frequency and voltage as quickly as its control system allows. In addition, a converter with grid-following power exchange impresses a current by the exchanged power being controlled to a setpoint largely independently of the specific parameters of the grid. In contrast, grid-forming power exchange means that a converter generates an AC-side alternating voltage using a grid-forming control system, which may differ from the given grid voltage in terms of voltage angle and voltage amplitude, i.e., in terms of its phase and/or voltage. In this respect, grid-forming exchange of electrical power with a given grid is directly influenced by grid properties and grid events, such as grid frequency changes or grid phase shifts, with the influence of the grid-forming power exchange on these grid properties being rather limited. A plurality of voltage-source converters with grid-forming power exchange can, with suitable coordination or concertation, e.g. by means of a specific design or (higher-level) control system, be capable of maintaining or forming a (spatially limited) AC grid, e.g. a distribution grid. An island converter is ultimately capable of forming and maintaining a grid on its own, wherein the island converter can determine the frequency and voltage, in particular the voltage angle and voltage amplitude, of the grid to be established. However, the grid established by an island converter is substantially dependent on the capabilities of the specific converter and is therefore usually spatially limited, e.g. a local island grid.

Various types of grid events can occur in an alternating current grid. For example, the grid frequency can change with different signs, i.e., increase or decrease. A grid-forming control system must autonomously react to such grid events and, according to its capabilities, make power changes with correspondingly different signs to help stabilize the grid.

DE 10 2020 119 039 A1 discloses a system comprising inverters, which operate as voltage sources by using a corresponding droop control system and can react instantaneously to grid events by changing the power. A system controller adapts parameters of the droop control systems, wherein the adaptation includes changing the frequency setpoint and/or the power setpoint in response to a power change, in order to return the power of the system to a grid power setpoint after a grid event. This solution makes it possible to precisely set the exchange power at the mains connection to the grid power setpoint.

WO 2023 224 648 A1 discloses a control system for a PV inverter, comprising a power-frequency droop control system, which enables, among other things, establishing an island grid and grid-forming operation on an AC grid, wherein, during grid-forming operation, a frequency control value of the power-frequency droop is modified on the basis of the difference between the actual power and a reference power.

EP 2 469 680 B1 discloses a PV inverter comprising a droop control system, in which an inverter phase angle is determined from a frequency control value that is set based on the difference between the actual power and a power setpoint. The target power setpoint corresponds to the maximum possible power (MPP power) of the PV generator. The inverter phase angle can be additionally corrected with a phase correction value, which is set based on the difference between the actual DC voltage and a DC voltage setpoint.

U.S. Pat. No. 11,316,347 B2 discloses a control unit for a so-called Virtual Synchronous

Generator, which, during grid-following operation with a PV generator, adjusts its AC power using a direction-dependent P(df/dt) control system. The direction dependency can be adjusted using a power limiting block.

### SUMMARY

The disclosure is directed to a method for operating a power converter that improves the grid-forming exchange of electrical power between a DC unit and an AC voltage grid.

In a method according to the disclosure for operating a power converter, the power converter is configured to exchange electrical power between a DC unit and an AC grid. The DC unit is connected to a DC terminal of the power converter and exchanges DC power with the power converter depending on a DC voltage at the DC terminal. The AC grid is connected to an AC terminal of the power converter and exchanges AC power with the power converter depending on a voltage profile deviation between an AC voltage profile, which is generated at the AC terminal by a clocked bridge circuit of the power converter, and a grid voltage profile.

The power converter adjusts the AC voltage profile using a grid-forming AC control system as a function of an AC power control value; i.e., the power converter is in principle in a voltage-source operating mode. In one embodiment, the AC control system can take into account a power setpoint, which represents, for example, a power that is to be exchanged between the DC unit and the AC grid during steady-state normal operation, especially if the electrical parameters of the AC grid are within a standard range. The AC power control value can correspond to the power setpoint or be derived therefrom within the scope of the method, e.g. by using the AC power control value to set the power setpoint during steady-state normal operation.

During grid events, the AC power varies with an adjustable induced power response, wherein the induced power response includes a dynamic AC power deviation between the AC power and the power setpoint so that an adjustable control power is induced by a grid event and, for example, an instantaneous reserve power is exchanged with the AC grid.

The method according to the disclosure is characterized in that the induced power response to a grid event is adjusted using an asymmetry characteristic. An asymmetry characteristic according to the disclosure specifies different gains of a parameter of the grid-forming AC control system and/or of a DC controller connected to the grid-forming AC control system as a function of the sign of a deviation between the parameter and a parameter limit. The parameter may comprise, for example, the difference between the DC voltage and a DC voltage setpoint and/or the difference between the AC power and the AC power control value.

The method according to the disclosure allows the power converter to react to a grid event in different ways using the asymmetry characteristic depending on the sign of the grid event and of the power response thus induced as a result of the voltage-source operation. The sign of the grid event is reflected in the sign of the parameter, for example, by the fact that a grid event causes a deviation between the grid voltage profile and the AC voltage profile of the power converter, and a grid-forming change in the AC power takes place, which in turn results in an AC power difference in the AC control system and/or a DC voltage difference in the DC controller. The asymmetric amplification of the deviation between at least one of these parameters and the associated parameter limit thus influences the power response induced by a specific grid event, for example, the resulting dynamic AC power deviation between the AC power and the power setpoint. By specifically designing the asymmetry characteristic and the parameter limit, particular attention can thus be paid to the properties of the DC unit used, ensuring, for example, that electrical power is actually available for the power response to possible grid events and can be exchanged between the DC unit and the AC grid.

In one embodiment, the parameter limit can specifically have the value zero so that the asymmetry characteristic has different slopes depending on the sign of the difference between the DC voltage and a DC voltage setpoint and/or on the sign of the difference between the AC power and an AC power control value. This allows the power response to vary depending directly on the sign of the grid event. This is advantageous in one embodiment if the response to grid events with different signs is intended to be as asymmetrical as possible, i.e., with fundamentally different AC power deviations, e.g., in case a DC unit connected to the power converter can or is intended to only change its power in one direction from the power setpoint.

In an alternative embodiment, the parameter limit can specifically be a value that is unequal to zero so that the asymmetry characteristic has different slopes depending on which side of the associated parameter limit the parameter lies on. This allows the power response to initially occur with the same gain regardless of the grid event sign, and the parameter is amplified differently when it passes the associated parameter limit. This is advantageous in one embodiment if the response to grid events is intended to have at least a limited degree of symmetry, i.e., providing dynamic AC power deviations that are identical in size regardless of the sign of the grid event, e.g., because the DC unit specifically connected to the power converter can change its power to a certain extent in both directions from the power setpoint, but only until it reaches the parameter limit in one embodiment, i.e., up to a specifiable maximum AC power difference and/or a maximum DC voltage difference caused by the power response.

Specifically, within the context of the disclosed method, the DC unit can comprise a battery, a PV generator, and/or an electrolyzer. Starting from a power setpoint and the associated power exchanged between the DC unit and the AC grid during steady-state normal operation, a battery can, in principle, exchange a higher or lower DC power and thus support a symmetrical power response, but only as long as a corresponding storage capacity is available in the battery; if the battery is, for example, completely empty or completely full and/or if the battery has charging and discharging capacities with different limits, operation with the asymmetry characteristic according to the disclosure is advantageous. A PV generator in principle exhibits non-linear power behavior and, during steady-state normal operation, can be operated close to the maximum power point (MPP) so that only a very small increase in DC power is possible and should be avoided, in particular to prevent instabilities in the control system of the power converter; this can be taken into account using the asymmetry characteristic according to the disclosure, for example by amplifying a DC voltage difference, induced by a grid event, between the DC voltage and an MPP voltage of the PV generator as the DC voltage setpoint in different ways, depending on what sign the DC voltage difference has. During steady-state normal operation, an electrolyzer is regularly operated with a power setpoint that is close to the maximum power of the electrolyzer so that a symmetrical dynamic AC power deviation due to a grid event is in principle possible, but only as long as the AC power difference does not exceed an associated parameter limit, i.e., the maximum permissible power increase. Here, the asymmetry characteristic according to the disclosure can advantageously be used due to having different slopes on either side of the parameter limit and, for example, by being able to prevent escalation, such as overloading of the electrolyzer, and/or shutdown of the DC unit, when the parameter limit is exceeded in response to a grid event.

In one embodiment of the method, the grid event includes a grid frequency event, wherein the voltage profile deviation includes a phase angle difference between an AC phase angle at the AC terminal of the power converter and a grid voltage phase angle. The AC phase angle at the AC terminal is specified by the AC control system and set by the bridge circuit of the power converter. A grid frequency event, such as a grid frequency change or a grid phase shift, causes a change in the phase angle difference for an initially specified AC voltage profile, and thus automatically induces a power response of the power converter, which in turn leads to a change in the parameter AC power difference and/or DC voltage difference. Using the asymmetry characteristic according to the disclosure, this parameter change is amplified differently depending on what sign the phase angle difference change has, thus enabling an asymmetric power response to grid frequency events with different signs.

In another embodiment of the method, the AC power control value of the grid-forming AC control system is specified by the DC controller. The AC power control value can depend in particular on the difference between the DC voltage and the DC voltage setpoint and/or on the difference between a DC current and a DC current setpoint. This allows, for example, the DC controller to influence the AC power using the AC power control value in such a way that a deviation between the DC voltage and the DC voltage setpoint is reduced, and therefore the desired DC voltage and thus a potentially corresponding power setpoint can be reached and maintained at least during steady-state normal operation.

In one embodiment, the asymmetry characteristic can comprise an inertia asymmetry characteristic, which is applied in the AC control system to the difference between the AC power and the AC power control value. Alternatively or additionally, the asymmetry characteristic can comprise an inertia asymmetry characteristic, which is applied in the DC controller to the difference between the DC voltage and the DC voltage setpoint. In principle, a plurality of entities of asymmetry characteristics can thus be used in the method according to the disclosure, for example, a plurality of inertia asymmetry characteristics in the grid-forming AC control system and in the DC controller, which, through their interaction, determine asymmetric inertia of the power response of the power converter induced by a grid event. The use of at least one inertia asymmetry characteristic, for example, enables the provision of asymmetric control power, for example, asymmetric instantaneous reserve power, wherein the control power on either side of the parameter limit can yield control energy that differs significantly in magnitude. For example, a PV generator can be operated at the maximum power point (MPP) by the power converter, in particular by the DC controller, while the power converter simultaneously reacts to grid events in a grid-forming manner. This can be achieved by temporarily allowing an AC power deviation from the MPP power of the PV generator toward lower power and/or a DC voltage difference from the MPP voltage of the PV generator toward higher DC voltages by using a relatively low gain of the corresponding parameter. On the other hand, AC power beyond the MPP power and/or DC voltage below the MPP voltage, and thus beyond the associated parameter limits, can be reliably suppressed by a relatively high gain of the corresponding parameter.

In embodiments of the method, the slopes of the inertia asymmetry characteristic on either side of the parameter limit for the AC power difference or for the DC voltage difference can differ by at least a factor of 2, for example, or at least a factor of 5. This results in different changes to the AC power in terms of its magnitude and profile for different signs of the parameter deviation from the parameter limit in the grid-following AC control system, and thus an induced power response with asymmetric inertia. As a rough guideline, the inertia asymmetry characteristic can be designed such that the resulting power response comprises a control power which, depending on the sign of, for example, a grid frequency event, yields control energy that differs by at least a factor of 2, for example, by at least a factor of 5.

In one embodiment of the method, the grid-forming AC control system comprises a droop controller in which an AC phase angle is determined for the AC voltage profile. For this purpose, a droop reference power or an AC droop difference between the current AC power and the droop reference power is multiplied by a droop factor, the resulting product is added as a frequency offset to a nominal frequency, and the resulting sum representing the target frequency is integrated. The resulting phase angle can be set by appropriately clocking the bridge circuit of the power converter so that a corresponding AC voltage profile is created at the AC terminal of the power converter. Such a droop controller is also called an f(P) controller and can, in particular, automatically adjust the frequency of the AC voltage profile to the frequency of the grid voltage profile, although, depending on the selected droop factor, a significant phase angle difference and a corresponding AC power flow can be readily associated with a change in grid frequency.

In another embodiment of the method, the asymmetry characteristic can comprise a droop asymmetry characteristic that is applied to the droop reference power or to the AC droop difference in the droop controller and whose different gain depends on the sign of its respective deviation from a parameter limit. Alternatively or additionally, the asymmetry characteristic can comprise an asymmetry droop gain, which specifies an asymmetry droop gain as a function of a droop power change rate of the droop reference power or the AC droop difference, wherein the asymmetry droop gain is applied in the droop controller to the droop reference power or to the AC droop difference between the current AC power and the droop reference power. In one embodiment, the asymmetry droop gain can have different slopes depending on the sign of the droop power change rate. The slope of the asymmetry droop gain can have the value zero in particular for a first sign of the droop power change rate and have a value that is greater than zero, preferably a value greater than 1, for the other sign of the droop power change rate.

The droop asymmetry characteristic and the asymmetry droop gain thus make it possible, for example, to configure that the target frequency of the grid-forming AC control system is adapted to the changed frequency of the grid voltage profile at different speeds in the case of grid frequency events with different signs of the induced power response. As a result, grid frequency events with different signs result in different-sized changes in phase angle differences and correspondingly different-sized dynamic AC power deviations between the AC power and the power setpoint. When operating a PV generator at the MPP, this difference can be advantageously used, for example, to avoid increasing the phase angle difference and thus increasing the AC power to a value beyond the MPP power by having the AC setpoint frequency react to an increase in AC power with high gain and quickly resynchronize the AC phase angle with the grid voltage phase angle. However, a reduction in the phase angle difference and thus a reduction in AC power due to a corresponding grid frequency event can be permitted in that the AC setpoint frequency responds to a reduction in AC power with relatively low gain by means of the droop asymmetry characteristic. Furthermore, in one embodiment, the application of asymmetry droop gain on the basis of the droop power change rate can enable an asymmetric grid-forming response to a gradient of the droop reference power or the AC droop difference, i.e., already making a control power asymmetric independently of the position of the droop reference power or the AC droop difference relative to the associated parameter limit.

In one embodiment of the method, the AC control system comprises an inertia controller. In the inertia controller, the droop reference power is determined, for example, by integrating the AC power difference after applying the inertia asymmetry characteristic and multiplying the resulting integral by an inertia factor. Integrating the AC power difference over time when determining the droop reference power in particular ensures that the change in the phase angle difference associated with a grid frequency event is reversed in such a way that the power response of the grid-forming control system takes on the character of an instantaneous reserve power. The inertia factor can be of such a size that, for example, the power response induced by a change in grid frequency is proportional to the frequency change rate. The application of the inertia asymmetry characteristic when determining the droop reference power in the inertia controller also enables a particularly good adaptation of the grid-forming AC control system to the properties of the DC unit used. This ensures, for example, that the available power and energy reserves of the DC unit can actually be exchanged between the DC unit and the AC grid for the power response to possible grid events, especially if these power and energy reserves themselves are asymmetrical. For this purpose, when operating a PV generator, for example, a stronger counter-reaction of the droop controller can occur when the AC power is increased above the MPP power and/or the DC voltage drops below the MPP voltage as a result of a grid frequency event, as compared to a reduction in AC power due to a grid frequency event, which is not critical in itself. This is because applying the inertia asymmetry characteristic to the AC power difference results in a greater increase in the droop reference power or the AC droop difference for an AC power difference with a negative sign compared with for an AC power difference with a positive sign. This allows, in one embodiment, the creation of a negative instantaneous reserve and the effective suppression of a positive instantaneous reserve at the same time. Conversely, when operating an electrolyzer at its nominal DC power, for example, a positive instantaneous reserve can be generated and supported by reducing the electrolysis power, while at the same time a negative instantaneous reserve and any increase in the electrolysis power beyond the nominal power can be effectively suppressed. When operating a battery as a DC unit, the instantaneous reserve can be selected asymmetrically depending on the state of charge, for example.

In one embodiment of the method, the AC power control value is determined in the DC controller by integrating the DC voltage difference between the DC voltage and the DC voltage setpoint after applying the inertia asymmetry characteristic and multiplying it by an inertia factor, wherein the AC power control value thus determined is used in particular as the droop reference power. The AC power control value determined in the DC controller can additionally comprise a proportional component, which is the product of the DC voltage difference and a DC proportional factor, wherein the DC proportional factor preferably differs depending on what sign the DC voltage difference has. Integrating the DC voltage difference over time when determining the AC power control value for grid-forming AC control system ensures, in one embodiment, that the change in DC voltage associated with the power response induced by a grid frequency event is reversed by the change in the AC power control value reversing the change in the phase angle difference associated with a grid frequency event. Furthermore, by applying the inertia asymmetry characteristic to the DC voltage difference, this reversal can be asymmetrical by amplifying DC voltage differences with different signs to different degrees and correspondingly adjusting them at different speeds. This allows, for example, for implementing an asymmetric instantaneous reserve or refining an asymmetric instantaneous reserve in combination with other entities of asymmetry characteristics in the grid-forming AC control system, for example, to optimally utilize the potentially asymmetrically available power and energy reserves of the DC unit used for forming the grid.

In further embodiments of the method, the power converter can comprise a DC current controller which, depending on the connected DC unit, performs battery current control, MPPT control and/or electrolysis current control. The DC current controller can be connected upstream of the DC controller of the power converter so that the DC controller receives the DC voltage setpoint from the DC current controller.

In the case of a PV generator as a DC unit, the DC current controller, in one embodiment, performs MPPT control to set and track the maximum power point (MPP) of the PV generator. For this purpose, the DC current controller can gradually change the DC voltage setpoint to maximize the DC power of a connected PV generator, with the direction in which the DC voltage setpoint is changed depending on the direction in which the DC power of the PV generator is changed for previously set DC voltage setpoints. Each of the DC voltage setpoints are then preferably taken into account by the DC controller or directly by the AC control system and set during steady-state normal operation in the absence of grid events, so that the MPP power indirectly serves as the power setpoint. In an extended embodiment of the DC current controller, the MPPT control can set an operating point of the PV generator whose DC power deviates from the current MPP power by a fixed or variable amount. This allows a power reserve to be created, which can be used as a corresponding shift in the parameter limit for the AC power difference.

Similarly, the DC current controller can change the DC voltage setpoint for electrolysis current control based on the DC current to a connected electrolyzer in order to set a specified DC electrolysis current setpoint as the power setpoint during steady-state normal operation and to optionally maintain a power reserve above the DC electrolysis current setpoint, which can be taken into account as the parameter limit for the AC power difference. In the case of a battery as a DC unit, the DC current controller can change the DC voltage setpoint for battery current control based on the DC current to the connected battery to set a specified DC battery current setpoint as the power setpoint during steady-state normal operation. At the same time, the application of the asymmetry characteristic in the grid-forming AC control system enables an asymmetrically adjustable power response to a grid event, for example, an asymmetric instantaneous reserve in the event of a grid frequency event, with optimal use of the actual, potentially asymmetric, power and energy reserves of the specific DC unit used.

A power converter according to the disclosure for exchanging electrical power between a DC unit and an AC grid comprises a DC intermediate circuit, a bridge circuit with controllable semiconductor switches and a control unit. The power converter and, in particular, the control unit of the power converter are configured to perform a grid-forming AC control of the AC voltage profile at an AC terminal of the power converter. The power converter according to the disclosure is characterized in that the control unit or circuit is configured to execute one of the methods according to the disclosure as described above.

An energy supply system according to the disclosure comprises a power converter which can be connected to a DC unit via a DC terminal and to an AC grid via an AC terminal, wherein the power converter is operated using one of the methods according to the disclosure as described above. The DC unit can, for example, include a battery, a PV generator, or an electrolyzer. In a specific embodiment of the energy supply system, the DC unit comprises a PV generator or an electrolyzer, which themselves have no dedicated energy storage capability. In one embodiment, the power converter can be configured to exchange asymmetric control power with the AC grid in the event of a grid frequency event, wherein the control power depends on what sign the grid frequency event has. For this purpose, the power converter has, in one embodiment, an energy storage capacity that is at least a factor of 10, for example, or at least a factor of 100, smaller than the control energy that is exchanged during a grid frequency event which induces a relatively high control power due to its sign. In one embodiment, the energy generation system and the power converter comprise no further energy storage devices in the power path besides the intermediate circuit capacitor of a conventional DC intermediate circuit. Based on the method according to the disclosure, the energy supply system according to the disclosure is nevertheless able to perform grid-forming AC control and, in particular, to contribute significantly to the stabilization of the AC grid by providing control power during grid events.

### BRIEF DESCRIPTION OF THE FIGURES

The disclosure is further explained and described below with reference to example

embodiments illustrated in the figures.

FIG. 1 shows a first embodiment of the method according to the disclosure.

FIG. 2 shows a second embodiment of the method according to the disclosure.

FIG. 3 shows a third embodiment of the method according to the disclosure.

FIG. 4 shows a fourth embodiment of the method according to the disclosure.

FIG. 5 shows a fifth embodiment of the method according to the disclosure.

FIG. 6 shows a sixth embodiment of the method according to the disclosure.

FIG. 7 shows a seventh embodiment of the method according to the disclosure.

FIG. 8 shows an eighth embodiment of the method according to the disclosure.

FIG. 9 shows an example time profile of a grid frequency and an AC power when applying the method according to the disclosure.

The same reference signs are used in the figures for identical or similar elements.

The representations shown in the figures are not necessarily to scale.

### DETAILED DESCRIPTION

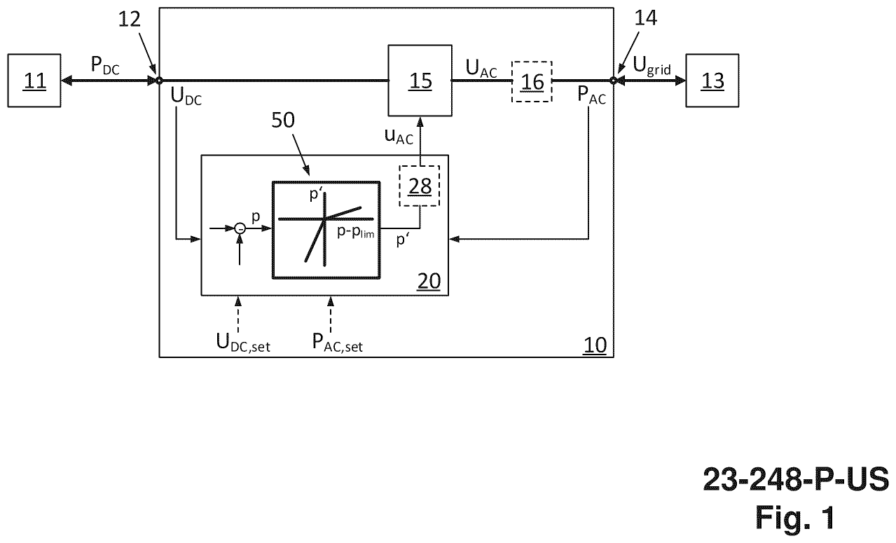

FIG. 1 schematically shows an energy supply system comprising a power converter 10, which is designed for exchanging electrical power P_{DC}, P_{AC} between a DC unit 11 and an AC grid 13. The DC unit 10 is connected to a DC terminal 12 of the power converter 10 and exchanges a DC power P_{DC} with the power converter 10 based on a DC voltage U_{DC} at the DC terminal 12. The DC unit 11 can, in one embodiment, include a battery, a PV generator, and/or an electrolyzer. The AC grid 13 is connected to an AC terminal 14 of the power converter 10 and exchanges an AC power P_{AC} with the power converter 10 via the AC terminal 14, wherein the AC power P_{AC} is based on a voltage profile deviation between an AC voltage profile U_{AC} generated by a pulsed bridge circuit 15 of the power converter 10 and a grid voltage profile U_{grid} at the AC terminal 14. Optionally, there is an AC filter 16 between the bridge circuit 15 and the AC terminal 14, across which the voltage profile deviation drops. The DC voltage U_{DC} and/or the AC power P_{AC} can be detected using suitable measuring instruments. Within the scope of this disclosure, it goes without saying that the quantities voltage, current and power are interrelated on both the AC and DC sides so that power can, for example, be specified as current at a given voltage, or vice versa.

The power converter 10 comprises a grid-forming AC control system 20. The power converter 10 uses the grid-forming AC control system 20 to generate the AC voltage profile U_{AC} as a function of a power control value P_{AC,set} set. Due to the grid-following properties of the AC control system 20, AC power P_{AC} flows depending on the voltage profile deviation of the specific profile of the grid voltage U_{grid} relative to the AC voltage profile U_{AC}. The actual voltage profile deviation comprises, for example, a phase angle difference between an AC phase angle ϑ that is set by the bridge circuit 15 and a grid voltage phase angle, wherein the AC phase angle ϑ is specified by the AC control system 20. By means of the grid-forming AC control system 20, the AC power P_{AC} varies during grid events, especially during grid frequency events such as changes in grid frequency or phase shifts in the grid voltage profile, which yields an adjustable induced power response.

The power response induced by grid events includes a dynamic AC power deviation between the AC power P_{AC} and a power setpoint, which can correspond, for example, to the AC power control value P_{AC,set} set. The AC power control value P_{AC,set} can also be specified by a DC controller 30 and can, for example, depend on a DC voltage difference ΔU_{DC} between the DC voltage U_{DC} and a DC voltage setpoint U_{DC,set} set and/or on a DC current difference ΔI_{DC} between a DC current I_{DC} and a DC current setpoint I_{DC,set} set. During stationary operation with an AC grid 14, whose electrical parameters are within the normal range and substantially stable, the grid-forming AC control system 20 for the AC voltage U_{AC} provides an AC power P_{AC}, which essentially equals a power setpoint for the energy supply system, for example, a MPP power for a PV generator, a desired electrolysis power for an electrolyzer, or a demanded battery current for a battery as a DC unit 11.

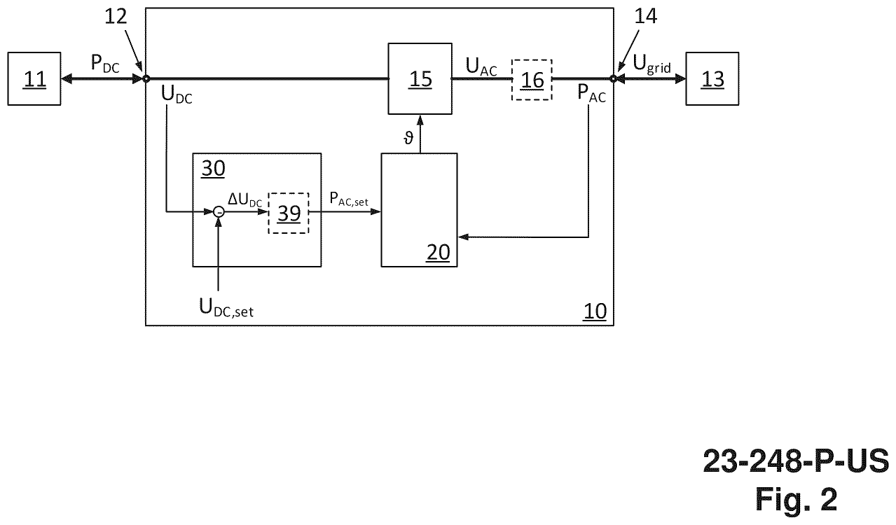

The power response induced by a grid event is adjusted using an asymmetry characteristic 50. The asymmetry characteristic 50 specifies different gains of a parameter p of the AC control system 20 and/or a DC controller 30 (see FIG. 2ff) as a function of the sign of a deviation p-pₗᵢₘ between the parameter p and a parameter limit pₗᵢₘ. In the example of FIG. 1, the different gains are implemented as different slopes of the asymmetry characteristic 50, which assigns to the parameter p the correspondingly amplified parameter p′, taking into consideration its distance from the parameter limit pₗᵢₘ; here, the asymmetry characteristic 50 may be defined, in one embodiment, as a simple lookup table.

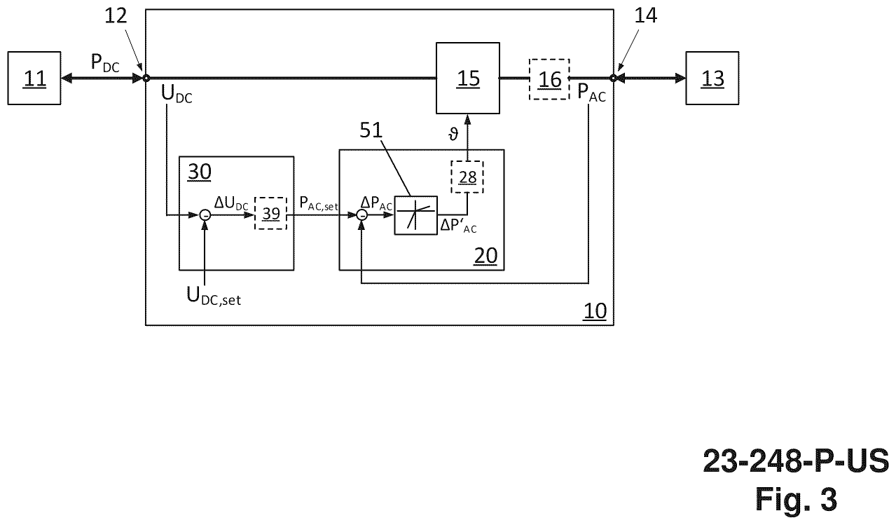

The parameter p can, for example, comprise a DC voltage difference ΔU_{DC} between the DC voltage U_{DC} and the DC voltage setpoint U_{DC,set} set (see FIG. 2) and/or an AC power difference ΔP_{AC} between the AC power P_{AC} and the AC power control value P_{AC,set} set (see FIG. 3). Via further AC control elements 28, e.g. proportional controllers and/or integrator circuits, the asymmetrically amplified parameter p′ resulting from the application of the asymmetry characteristic 50 to the parameter p is used to derive a suitable AC voltage profile u_{AC}, which is passed to the bridge circuit 15 as a switching control signal. The AC voltage profile u_{AC} may alternatively be represented by one or more other values suitable for activating the bridge circuit 15, e.g. the corresponding phase angle ϑ of an AC voltage phasor (see FIG. 2).

FIG. 2 shows a specific embodiment of the method according to the disclosure, in which the AC power control value P_{AC,set} set is determined in a DC controller 30. A DC voltage difference ΔU_{DC} is calculated between the DC voltage U_{DC} and a DC voltage setpoint U_{DC,set} set, optionally processed via further DC control elements 39, e.g. proportional controllers and/or integrator circuits, and passed on to the grid-forming AC control system 20 as an AC power control value P_{AC,set} set. The grid-forming AC control system 20 sets the AC voltage U_{AC} by controlling the bridge circuit 15 using the phase angle ϑ, which is derived from the power control value P_{AC,set} set and the AC power P_{AC}, for example, using a suitable droop controller or the like.

FIG. 3 shows a further embodiment of the method according to the disclosure, in which the DC controller 30 determines the AC power control value P_{AC,set} set based on the voltage difference ΔU_{DC} and passes it to the AC controller 20. In the AC controller 20, an AC power difference ΔP_{AC} between the AC power P_{AC} and the AC power control value P_{AC,set} set is formed. An inertia asymmetry characteristic 51 is applied to the AC power difference ΔP_{AC}, which assigns a modified AC power difference ΔP′_{AC} to the AC power difference ΔP_{AC}. The modified AC power difference ΔP′_{AC} is amplified differently over the AC power difference ΔP_{AC} depending on the sign of the deviation between the AC power difference ΔP_{AC} and a limit P_{AC,lim} . In the simplest case, the l_{AC,lim} is equal to zero so that the AC power difference ΔP_{AC} is multiplied by a constant corresponding to the slope of the inertia asymmetry characteristic 51, wherein the slope of the inertia asymmetry characteristic 51, hence the constant, differs depending on the sign of the AC power difference ΔP_{AC}. The phase angle ϑ is determined based on the AC power difference ΔP′_{AC} asymmetrically modified in this way via further AC control elements 28, e.g. a suitable droop controller, and used to control the bridge circuit 15.

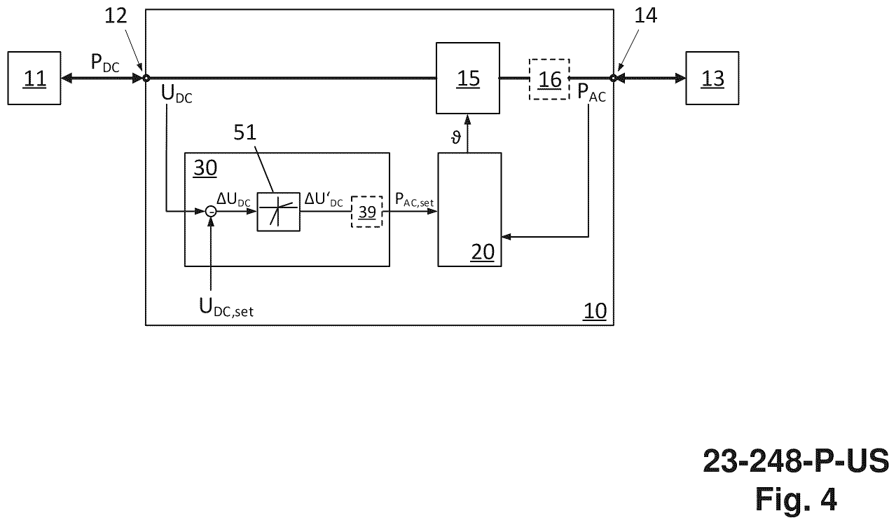

FIG. 4 shows a further embodiment of the method according to the disclosure, in which the DC controller 30 determines the AC power control value P_{AC,set} set by applying an inertia asymmetry characteristic 51 to the voltage difference ΔU_{DC}. The inertia asymmetry characteristic 51 amplifies the voltage difference ΔU_{DC} as a function of the sign of the deviation between the voltage difference ΔU_{DC} and a limit U_{DC},ₗᵢₘ lim to varying degrees. In the simplest case, the limit U_{DC,lim} is equal to zero so that the voltage difference ΔU_{DC} is multiplied by a constant corresponding to the slope of the inertia asymmetry characteristic 51, wherein the slope of the inertia asymmetry characteristic 51 differs depending on the sign the voltage difference ΔU_{DC}. From the voltage difference ΔU′_{DC} asymmetrically modified in this way, the AC power control value P_{AC,set} set is determined via further DC control elements 39. The grid-forming AC control system 20 sets the AC voltage U_{AC} based on the AC power control value P_{AC,set} set and the AC power P_{AC} and controls the bridge circuit 15 accordingly using the phase angle ϑ.

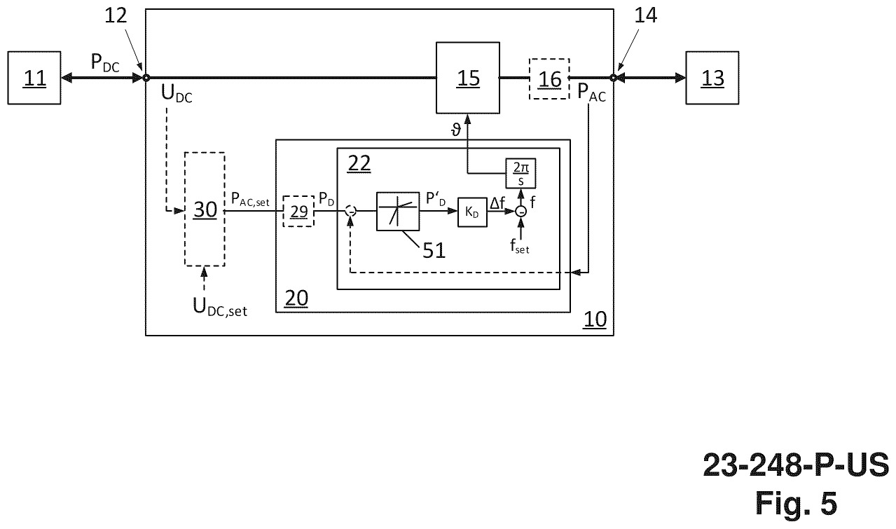

FIG. 5 shows a further embodiment of the method according to the disclosure, in which the AC control system 20 comprises a droop controller 22. In the droop controller 22, the phase angle ϑ of the AC voltage U_{AC} is determined based on a droop reference power P_{D}, which can correspond to the AC power control value P_{AC,set} set or be derived therefrom via further optional AC control elements 29. The droop reference power P_{D} (or an AC droop difference ΔP_{D} between the current AC power P_{AC} and the droop reference power P_{D}, shown optionally here with dashed lines) is asymmetrically amplified using a droop asymmetry characteristic 51, wherein the slope of the droop asymmetry characteristic is different depending on the sign of the deviation between the droop reference power P_{D} and a limit P_{D,lim} . The resulting asymmetrically modified droop reference power P′_{D} (or AC droop difference ΔP′_{D}) is multiplied with a droop factor K_{D}, and the resulting product is added as a frequency offset to a nominal frequency. The resulting sum is considered as the target frequency f and integrated in an integrator 2π/f to obtain the phase angle ϑ of the AC voltage U_{AC}, which is used to control the bridge circuit 15.

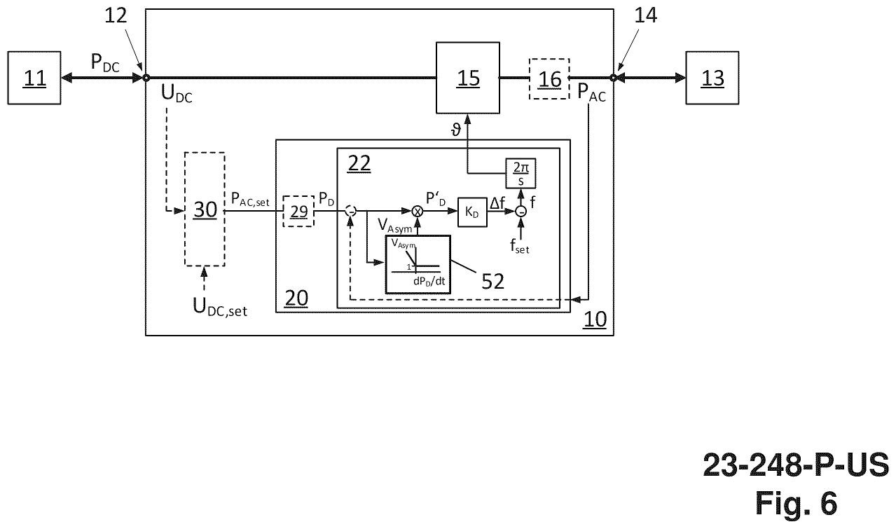

FIG. 6 shows a further embodiment of the method according to the disclosure, in which an asymmetry droop gain V_{Asym} is applied to the droop reference power P_{D} in the droop controller 22 (or optionally to the AC droop difference ΔP_{D}, shown only optionally here). The asymmetry droop gain V_{Asym} is specified based on a droop power change rate dP_{D}/dt of the droop reference power P_{D} (or of the AC droop difference ΔP_{D}, respectively) and can be represented as a droop asymmetry characteristic 52. The droop asymmetry characteristic 52 comprises different slopes, depending on the sign of the droop power change rate dP_{D}/dt. In the example according to FIG. 6, the slope of the asymmetry droop gain V_{Asym} is zero if the droop power change rate has a positive sign, i.e., the asymmetry droop gain V_{Asym} is a constant for positive values of the power change rate dP_{D}/dt. When the droop power change rate dP_{D}/dt has a negative sign, the slope of the asymmetry droop gain V_{Asym} has a value of approximately two so that the droop reference power P_{D} (or the AC droop difference ΔP_{D}) is more strongly amplified the faster the droop reference power P_{D} (or the AC droop difference ΔP_{D}) decreases. The resulting asymmetrically modified droop reference power P′_{D} (or AC droop difference ΔP′_{D}) is in turn multiplied by a droop factor K_{D}, the resulting product is added as a frequency offset to a nominal frequency fₛₑₜ, and the resulting sum is considered as the target frequency f and integrated in an integrator 2π/f to obtain the phase angle ϑ of the AC voltage U_{AC}, which is used to control the bridge circuit 15.

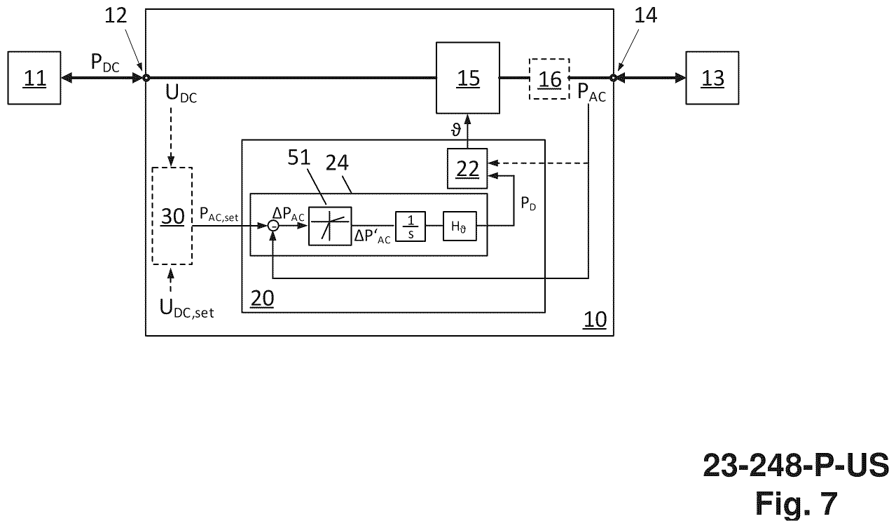

FIG. 7 shows a further embodiment of the method according to the disclosure, in which the AC control system 20 comprises an inertia controller 24 and the droop controller 22. The inertia controller 24 determines the droop reference power P_{D} for the droop controller 22 by first applying an inertia asymmetry characteristic 51 to the AC power difference ΔP_{AC} between the AC power P_{AC} and the AC power control value P_{AC,set} set. The resulting asymmetrically modified AC power difference ΔP′_{AC} (cf. FIG. 3) is integrated in an integrator 1/s and multiplied by an inertia factor H_{ϑ}. The resulting integral represents the deviation in AC power P_{AC} from the AC power control value P_{AC,set} set, which has accumulated during a grid event, and is passed as the droop reference power P_{D} to the droop controller 22. The droop controller 22 uses the droop reference power P_{D} to determine the phase angle ϑ, cf., e.g., FIG. 5. The application of the inertia asymmetry characteristic 51 in combination with the integrator 1/s in the inertia controller 24 generates a droop reference power that imparts an adjustable asymmetric inertia on the phase angle ϑ.

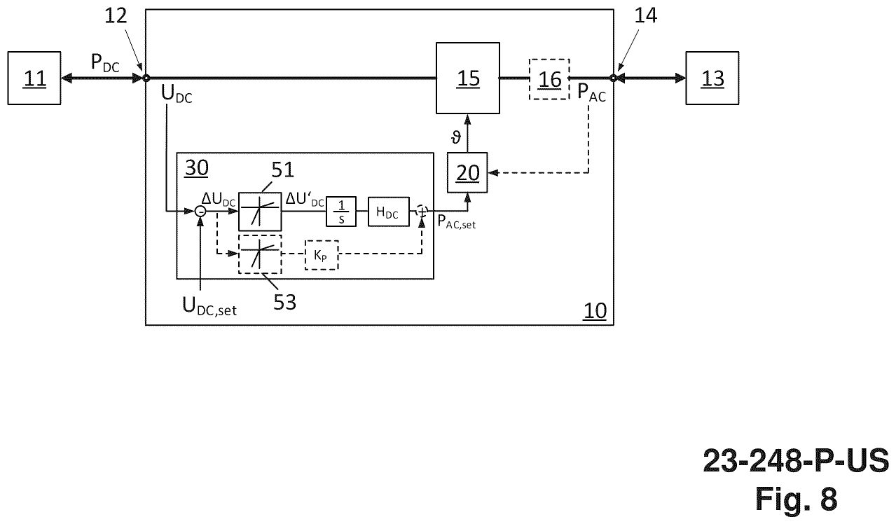

FIG. 8 shows a further embodiment of the method according to the disclosure, in which an inertia asymmetry characteristic 51 is applied to the voltage difference ΔU_{DC} in the DC controller 30 (see FIG. 4 for comparison). The voltage difference ΔU′_{DC}, which is thus asymmetrically modified, is integrated using an integrator 1/s and multiplied by a DC inertia factor H_{DC}. The resulting AC power control value P_{AC,set} set is used in the grid-forming AC control system 20 to determine the phase angle ϑ (cf., e.g., FIG. 7). Optionally, the AC power control value P_{AC,set} set can additionally comprise a proportional component, which is the product of the DC voltage difference ΔU_{DC} and a DC proportional factor K_{P}. Optionally, a further asymmetry characteristic 53 can be applied to the proportional component so that the proportional component can also differ depending the sign of the DC voltage difference ΔU_{DC}.

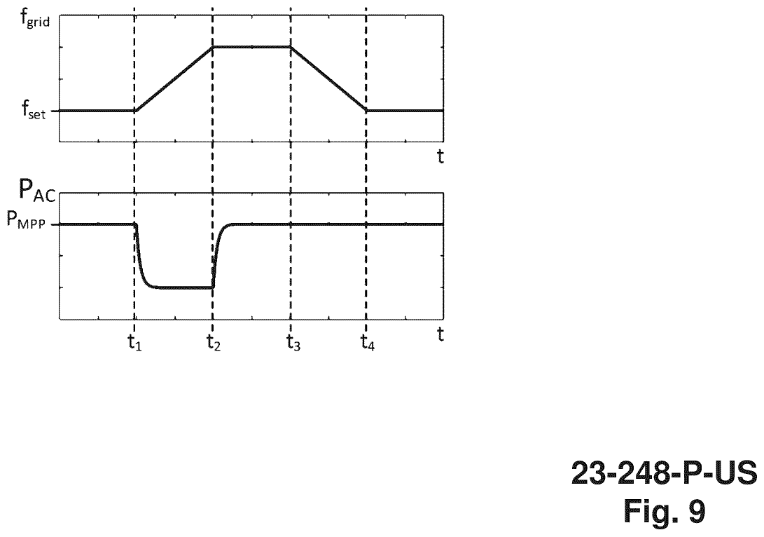

FIG. 9 shows an example profile of the grid frequency f_{grid} along a corresponding example profile of the AC power P_{AC} when applying the method according to the disclosure in an energy supply system comprising a PV generator as a DC unit 11, wherein the PV generator is to be substantially operated at the maximum power point (MPP).

Initially, the energy supply system and the AC grid 13 are in steady-state normal operation, with the grid frequency f_{grid} being constant at a nominal frequency fₛₑₜ and the exchanged powers P_{DC}, P_{AC} being identical to the MPP power P_{MPP}, except for operating losses. At time t₁, the grid frequency f_{grid} begins to increase at a constant rate. The grid-forming AC control system 10 responds to the grid frequency change with an induced change in AC power P_{AC}, which, after a short build-up phase, reaches a value that is lower than the MPP power P_{MPP} by the amount of a control power, for example, an instantaneous reserve power. Depending on the design of the grid-forming control system 20, the control power, i.e. the deviation from the MPP power P_{MPP} is proportional to the grid frequency change rate and is therefore constant as long as the grid frequency f_{grid} changes with a constant slope.

At time t₂, the grid frequency f_{grid} stabilizes at a higher level than the nominal frequency fₛₑₜ. At the same time, the control power is terminated by returning the AC power P_{AC} to the MPP power P_{MPP}. Between t₂ and t₃, the AC grid 13 is in a steady state with an increased grid frequency f_{grid}, wherein the AC power P_{AC} continues to correspond to the MPP power P_{MPP}. The AC power P_{AC} can, in one embodiment, be stabilized when the rate of change of frequency is constant as well as returned to the original power setpoint after the end of the grid frequency increase by using an inertia controller 24 in the AC control system 20 (cf. FIG. 7) and/or an inertia-imparting structure of the DC controller 30 (cf. FIG. 8).

At time t₃, the grid frequency f_{grid} begins to decrease at a constant rate. The grid-forming AC control system 10 responds to the grid frequency change with no change in AC power P_{AC}, i.e., the AC power P_{AC} continues to constantly correspond to the MPP power P_{MPP} of the PV generator. This suppression of a power response during a grid event with a specific sign can be achieved, in one embodiment, by using at least one suitably parameterized asymmetry characteristic 50, especially an inertia asymmetry characteristic 51 in the inertia controller 24 (cf. FIG. 7) and/or in the DC controller 30 (cf. FIG. 8), wherein a droop asymmetry characteristic 52 and/or an asymmetry characteristic 53 can optionally be used to, for example, set the transitions at the onset and at the end of a grid event more precisely.

At time t₄, the grid frequency excursion event has ended and the grid frequency corresponds to the nominal frequency fₛₑₜ again, while the AC power continues to correspond to the MPP power P_{MPP} of the PV generator again.

The energy supply system therefore behaves with maximum asymmetry with regard to grid events in that the grid-forming AC control system 20 of the power converter 10 only responds to a grid event with a first sign (here: increasing frequency between t₁ and t₂) with a change in AC power P_{AC}, while the AC power is otherwise kept constant at the MPP power, especially in the case of a grid event with a second sign (here: decreasing frequency between t₃ and t₄) which would normally induce an increase of the AC power P_{AC}; suppressing this power increase enables to utilize the renewably generated power and energy as completely and optimally as possible, in particular by avoiding the need to reduce the AC power P_{AC} below the MPP power P_{MPP} as a prophylactic measure.

A similar, complementary result with regard to AC control power can be achieved, for example, if the energy supply system is operated with an electrolyzer as a DC unit 11. For example, at least one asymmetry characteristic 50 can be used to reduce the DC power P_{DC} drawn from the electrolyzer and thus the AC power P_{AC} in the case of a negative gradient of the grid frequency f_{grid}, while the DC power P_{DC} and accordingly the AC power P_{AC} is kept essentially unchanged in the event of an increasing grid frequency f_{grid}.

When using a battery as a DC unit 11, various asymmetrical power responses to a grid event can be achieved, which, depending on the specific configuration of the asymmetry characteristic(s) 50, can be set somewhere between being as asymmetrical as possible (cf. FIG. 9) and being strictly symmetrical. The configuration of the asymmetry characteristic(s) 50 that is chosen may depend on further external factors, such as the state of charge of the battery.

What is claimed is:

1. A method for operating a power converter for exchanging electrical power (P_{DC}, P_{AC}) between a DC unit and an AC grid when coupled thereto, the DC unit being configured to be connected to a DC terminal of the power converter and exchanging a DC power (P_{DC}) with the power converter based on a DC voltage (U_{DC}) at the DC terminal, the AC grid being configured to be connected to an AC terminal of the power converter and exchanging an AC power (P_{AC}) with the power converter via the AC terminal based on a deviation between an AC voltage profile (U_{AC}) generated by a clocked bridge circuit of the power converter and a grid voltage profile (U_{grid}), wherein the power converter is configured to adjust the AC voltage profile (U_{AC}) using a grid-forming AC control system as a function of an AC power control value (P_{AC,set} ), wherein the AC power (P_{AC}) varies during grid events with an adjustable induced power response, the induced power response comprising a dynamic AC power deviation between the AC power (P_{AC}) and a power setpoint, wherein the power response to a grid event is adjusted using an asymmetry characteristic, wherein the asymmetry characteristic specifies different gains of a parameter (p) of the AC control system and/or a DC controller as a function of a sign of a deviation (p-pₗᵢₘ) between the parameter (p) and a parameter limit (pₗᵢₘ), wherein the parameter (p) comprises a DC voltage difference (ΔU_{DC}) between the DC voltage (U_{DC}) and a DC voltage setpoint (U_{DC,set} ) and/or an AC power difference (ΔP_{AC}) between the AC power (P_{AC}) and the AC power setpoint (P_{AC,set} ).

2. The method according to claim 1, wherein the parameter limit (pₗᵢₘ) has the value zero so that the asymmetry characteristic has different slopes depending on a sign of the DC voltage difference (ΔU_{DC}) between the DC voltage (U_{DC}) and the DC voltage setpoint (U_{DC,set} set) and/or on a sign of the AC power difference (ΔP_{AC}) between the AC po_{AC}r (PAC) and the AC power control value (P_{AC,set} ).

3. The method according to claim 1, wherein the parameter limit (pₗᵢₘ) has a value that is unequal to zero so that the asymmetry characteristic has different slopes depending on whether the parameter (p) is on one side or on an other side of the associated parameter limit (pₗᵢₘ).

4. The method according to claim 1, wherein the DC unit comprises a battery, a PV generator or an electrolyzer.

5. The method according to claim 1, wherein the grid event comprises a grid frequency event and the voltage profile deviation comprises the difference between an AC phase angle (ϑ) at the AC terminal of the power converter and a grid voltage phase angle, wherein the AC phase angle (ϑ) at the AC terminal is specified by the AC control system and set by the bridge circuit of the power converter.

6. The method according to claim 1, wherein the AC power control value (P_{AC,set} ) is specified by the DC controller and is dependent on the DC voltage difference (ΔU_{DC}) between the DC voltage (U_{DC}) and the DC voltage setpoint (U_{DC,set} ) and/or the DC current difference between a DC current and a DC current setpoint.

7. The method according to claim 1, wherein the asymmetry characteristic comprises an inertia asymmetry characteristic which is applied in the AC control system to the AC power difference (ΔP_{AC}) between the AC power (P_{AC}) and the AC power control value (P_{AC,set} ).

8. The method according to claim 1, wherein the asymmetry characteristic comprises an inertia asymmetry characteristic which is applied in the DC controller to the DC voltage difference (ΔU_{DC}) between the DC voltage (U_{DC}) and the DC voltage setpoint (U_{DC,set} ).

9. The method according to claim 7, wherein slopes of the inertia asymmetry characteristic on either side of the parameter limit (pₗᵢₘ) for the AC power difference (ΔP_{AC}) or for the DC voltage difference (ΔU_{DC}) differ by at least a factor of 2.

10. The method according to claim 1, wherein the AC control system comprises a droop controller, wherein the AC phase angle (ϑ) for the AC voltage profile (U_{AC}) is determined in the droop controller by multiplying a droop reference power (P_{D}) or an AC droop difference between the current AC power (P_{AC}) and the droop reference power (P_{D}) by a droop factor (K_{D}), the resulting product is added as the frequency offset (Δf) to a nominal frequency (fₛₑₜ), and the resulting sum is integrated as the target frequency (f).

11. The method according to claim 10, wherein the asymmetry characteristic comprises a droop asymmetry characteristic which is applied in the droop controller to the droop reference power (P_{D}) or to the AC droop difference.

12. The method according to claim 10, wherein the asymmetry characteristic comprises a droop asymmetry characteristic which specifies an asymmetry droop gain (V_{Asym}) as a function of a droop power change rate (dP_{D}/dt) of the droop reference power (P_{D}) or the AC droop difference, wherein the asymmetry droop gain (V_{Asym}) is applied in the droop controller to the droop reference power (P_{D}) or to the AC droop difference between the current AC power (P_{AC}) and the droop reference power (P_{D}).

13. The method according to claim 12, wherein the asymmetry droop gain (V_{Asym}) comprises different slopes depending the sign of the droop power change rate (dP_{D}/dt), wherein the slope of the asymmetry droop gain (V_{Asym}) has the value zero when the droop power change rate (dP_{D}/dt) has a first sign and has a value greater than zero, when the droop power change rate (dP_{D}/dt) has a second, opposite sign.

14. The method according to claim 10, wherein the AC control system comprises an inertia controller, wherein the droop reference power (P_{D}) is determined in the inertia controller by integrating the AC power difference (ΔP′_{AC}) after applying the asymmetry characteristic and multiplying the integral by an inertia factor (H_{ϑ}).

15. The method according to claim 10, wherein the AC power control value (P_{AC,set} ) is specified by the DC controller and is dependent on the DC voltage difference (ΔU_{DC}) between the DC voltage (U_{DC}) and the DC voltage setpoint (U_{DC,set} ) and/or the DC current difference between a DC current and a DC current setpoint, and wherein the AC power control value (P_{AC,set} ) is determined in the DC controller by integrating the DC voltage difference (ΔU′_{DC}) after applying the inertia asymmetry characteristic and multiplying the integral by an inertia factor (H_{DC}), wherein the AC power control value (P_{AC,set} ) determined is used as a droop reference power (P_{D}).

16. The method according to claim 15, wherein the AC power control value (P_{AC,set} ) determined in the DC controller additionally comprises a proportional component, which is the product of the DC voltage difference (ΔU_{DC}) and a DC proportional factor (K_{P}), wherein the DC proportional factor (K_{P}) differs depending a sign of the DC voltage difference (ΔU_{DC}).

17. The method according to claim 1, wherein the power converter comprises a DC current controller which performs battery current control, MPPT control and/or electrolysis current control.

18. The method according to claim 17, wherein the AC power control value (P_{AC,set} ) is specified by the DC controller and is dependent on the DC voltage difference (ΔU_{DC}) between the DC voltage (U_{DC}) and the DC voltage setpoint (U_{DC,set} ) and/or the DC current difference between a DC current and a DC current setpoint, and wherein the DC controller receives the DC voltage setpoint (U_{DC,set} ) from the DC current controller.

19. The method according to claim 18, wherein, for MPPT control, the DC current controller gradually changes the DC voltage setpoint (U_{DC,set} ) in order to maximize the DC power (P_{DC}) of a connected PV generator, wherein the direction of the change in the DC voltage setpoint (U_{DC,set} ) is dependent on the direction in which the DC power (P_{DC}) of the PV generator has changed for previously set DC voltage setpoints (U_{DC,set} ).

20. The method according to claim 18, wherein, for electrolysis current control, the DC current controller changes the DC voltage setpoint (U_{DC,set} ) based on the DC current to a connected electrolyzer to set a specified DC electrolysis current setpoint.

21. The method according to claim 18, wherein, for battery current control, the DC current controller changes the DC voltage setpoint (U_{DC,set} ) based on the DC current to a connected battery to set a specified DC battery current setpoint.

22. A power converter for exchanging electrical power (P_{DC}, P_{AC}) between a DC unit and an AC grid, comprising a DC intermediate circuit, a bridge circuit with controllable semiconductor switches and a control unit configured to perform a grid-forming AC control of the AC voltage profile (U_{AC}) at an AC terminal of the power converter using a method according to claim 1.

23. An energy supply system comprising a power converter which is connected to a DC unit via a DC terminal and to an AC grid via an AC terminal, wherein the power converter is operated by means of a method according to claim 1.

24. The energy supply system according to claim 23, wherein the DC unit comprises a PV generator or an electrolyzer without dedicated energy storage, wherein, in the event of a grid frequency event, the power converter is configured to exchange control power with the AC grid, the asymmetry of which is dependent on the sign of the grid frequency event, wherein the energy storage capacity of the power converter is at least a factor of 10, smaller than control energy that is exchanged with control power during a grid frequency event which induces a relatively high control power due to its sign.
